(19) United States
(12) Patent Application Publication
(10) Pub. No.: US 2023/0367136 A1
(43) Pub. Date: Nov. 16, 2023

(54) NON-CONTACT-TYPE INFORMATION PROCESSING DEVICE

(71) Applicant: NIDEC SANKYO CORPORATION, Nagano (JP)

(72) Inventors: Shinya MIYAZAWA, Nagano (JP); Yosuke OGUCHI, Nagano (JP); Junro TAKEUCHI, Nagano (JP); Masaya FUJIMOTO, Nagano (JP); Tsutomu BABA, Nagano (JP)

(21) Appl. No.: 18/016,791

(22) PCT Filed: Apr. 28, 2021
(86) PCT No.: PCT/JP2021/016982

§ 371 Date: Jan. 18, 2023

Related U.S. Application Data
(60) Provisional application No. 63/054,799, filed on Jul. 22, 2020.

(30) Foreign Application Priority Data
Jan. 26, 2021 (JP) 2021-010026

(51) Int. Cl. G02B 30/56; G06V 20/17; G06F 3/14

(52) U.S. Cl. CPC G02B 30/56; G06V 20/17; G06F 3/14; G06V 2201/07

(57) ABSTRACT

A non-contact-type information processing device includes a display mechanism having a display surface which displays an image, an aerial-image forming mechanism which forms an image as an aerial image by projecting the image displayed on display surface to a space, and an annularly formed antenna for communication. The antenna is disposed on an outer peripheral side of an aerial-image display region so as to surround the aerial-image display region, which is the region in which an aerial image is displayed.

### CROSS REFERENCE TO RELATED APPLICATIONS

This is the U.S. national stage of application No. PCT/JP2021/016982, filed on Apr. 28, 2021. Priority under 35 U.S.C. § 119(a) and 35 U.S.C. § 365(b) is claimed from Japanese Application No. 2021-010026, filed Jan. 26, 2021, and priority under 35 U.S.C. § 119(e) is claimed to U.S. Provisional Application No. 63/054,799, filed Jul. 22, 2020, the disclosure of which is also incorporated herein by reference.

### TECHNICAL FIELD

The present invention relates to a non-contact-type information processing device for contactless and manual communication of information with communication targets such as contactless IC (Integrated Circuit) cards, RFID (Radio Frequency Identification) tags, and smartphones.

### BACKGROUND ART

Conventionally, contactless IC card readers are known for communicating information with contactless IC cards in a contactless manner (see, Patent Literature 1, for example). The IC card reader described in Patent Literature 1 is used in a predetermined high-level device such as an ATM (Automated Teller Machine). This IC card reader has an annularly formed antenna for communication and a substrate on which the antenna is mounted.

### CITATION LIST

### Patent Literature

### [Patent Literature 1] Japanese Unexamined Patent Application Publication 2014-164732

### SUMMARY OF THE INVENTION

### Problems to be Solved by the Invention

The inventor of this application has developed a non-contact-type information processing device for contactless and manual communication of information with communication targets such as contactless IC cards, RFID tags, and smart phones. This non-contact-type information processing device includes an annularly formed antenna for communication similarly to the IC card reader described in Patent Literature 1.

Since this non-contact-type information processing device requires the user to hold a communication target in his/her hand over the antenna to communicate information between the antenna and the communication target, it is desirable that a disposed position of the antenna can be easily notified to the user. In this non-contact-type information processing device, if a conductor (electrical conductor) is disposed near the antenna, the communication characteristics of the antenna will be lowered due to eddy current losses and resonance frequency fluctuation on the conductor side, so that the antenna is preferably disposed at a position where the communication characteristics of the antenna can be easily secured.

Thus, an object of at least an embodiment of the present invention is, in a non-contact-type information processing device for contactless and manual communication of information with a communication target such as a contactless IC card, an RFID tag, and a smartphone, to provide a non-contact-type information processing device which can easily inform the user of the disposed position of an antenna for communication and can dispose an antenna at a position where communication characteristics of the antenna can be easily secured.

### Means for Solving the Problem

In order to solve the above problem, a non-contact-type information processing device of one aspect of the present invention is characterized by including, in a non-contact-type information processing device for contactless and manual communication of information with a communication target, a display mechanism having a display surface which displays an image, an aerial-image forming mechanism which forms an image as an aerial image by projecting the image displayed on a display surface to a space, and an annularly formed antenna for communication, in which the antenna is disposed on an outer peripheral side of an aerial-image display region so as to surround the aerial-image display region in which the aerial image is displayed.

In the non-contact-type information processing device of this aspect, the antenna is disposed on the outer peripheral side of the aerial-image display region so as to surround the aerial-image display region, which is the region in which the aerial image is displayed. Therefore, in this aspect, the disposed position of the antenna can be easily notified to the user by using the aerial image displayed in the aerial-image display region. In addition, in this aspect, since the antenna is disposed on the outer peripheral side of the aerial-image display region in which the aerial image is displayed, the antenna can be disposed at a position away from the conductor. Therefore, in this aspect, the antenna can be disposed at a position where the communication characteristics of the antenna can be easily secured.

In this aspect, the non-contact-type information processing device includes, for example, an annular substrate on which the antenna is mounted, and the aerial-image display region is formed on an inner peripheral side of the substrate. Moreover, in this aspect, the non-contact-type information processing device includes, for example, an enclosure in which the display mechanism and the aerial-image forming mechanism are accommodated, the enclosure has a frame body which surrounds the aerial-image display region, and the substrate is fixed to the frame body.

In this aspect, for example, the display mechanism displays a predetermined mark (logo) on the display surface in order to indicate a center position of the antenna, and the aerial-image forming mechanism displays the mark (logo) displayed on the display surface as an aerial image in the aerial-image display region. In this case, the user holds the communication target by using the mark (logo) displayed, as the aerial image in the aerial-image display region as a landmark.

In this aspect, it is preferable that the non-contact-type information processing device includes a control portion controlling the non-contact-type information processing device, the control portion determining, on the basis of a reception result of the antenna, whether normal communication has been completed or not between the communication target and the non-contact-type information processing device and, if a communication error that normal communication has not been completed between the communication target and the non-contact-type information processing device occurs, executes error notification control for notifying the occurrence of the communication error to the user, and in the error notification control, the display mechanism displays predetermined error indication on the display surface to notify the user of the communication error, and the aerial-image forming mechanism displays the error indication displayed on the display surface as an aerial image in the aerial-image display region. By configuring as above, occurrence of a communication error can be easily notified to the user.

### Effect of the Invention

As described above, in at least an embodiment of the present invention, in a non-contact-type information processing device for contactless and manual communication of information with a communication target such as a contactless IC card, an RFID tag, and a smartphone, the disposed position of the antenna for communication can be easily notified to the user, and the communication characteristics of the antenna can be easily secured.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are schematic diagrams for explaining a configuration of a non-contact-type information processing device according to an embodiment of the present invention.

FIG. 2 is a schematic diagram for explaining a configuration of an aerial-image display device used in the non-contact-type information processing device shown in FIG. 1.

FIGS. 3A and 3B are diagrams illustrating an example of an aerial image displayed in the aerial-image display region shown in FIGS. 1A and 1B.

### MODE FOR CARRYING OUT THE INVENTION

In the following, embodiments of the present invention will be described with reference to the drawings.

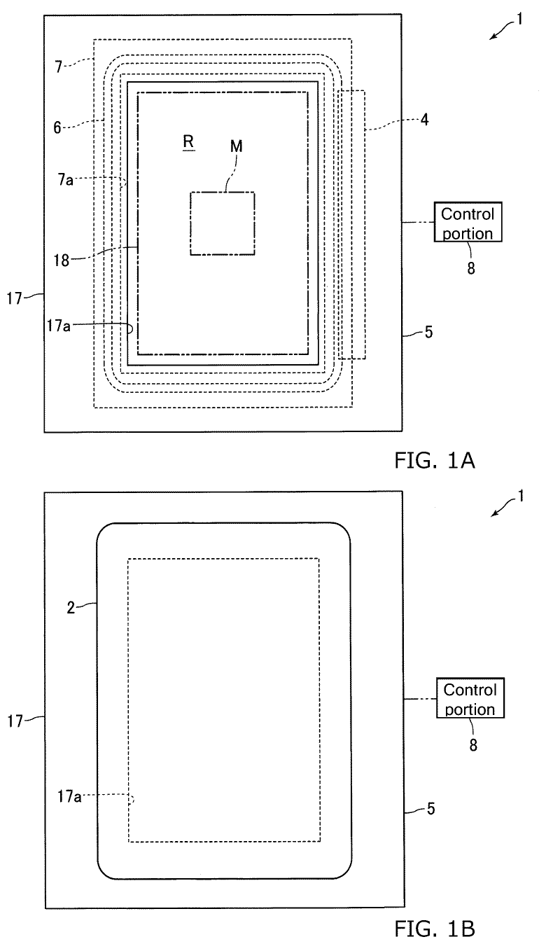

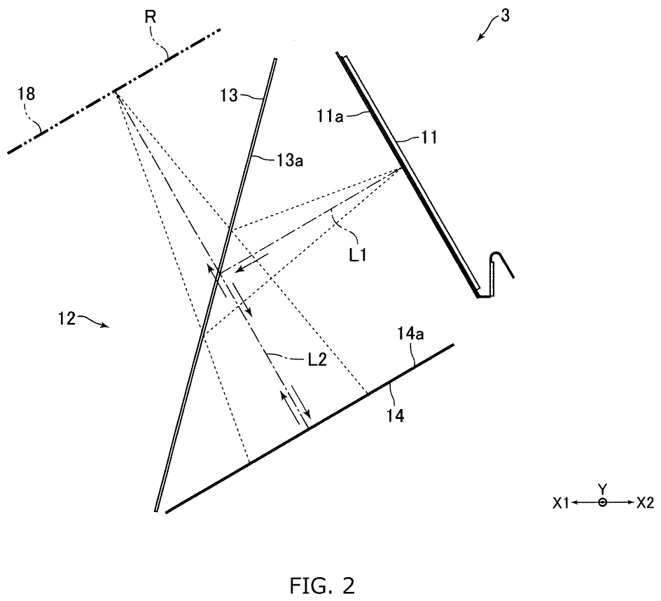

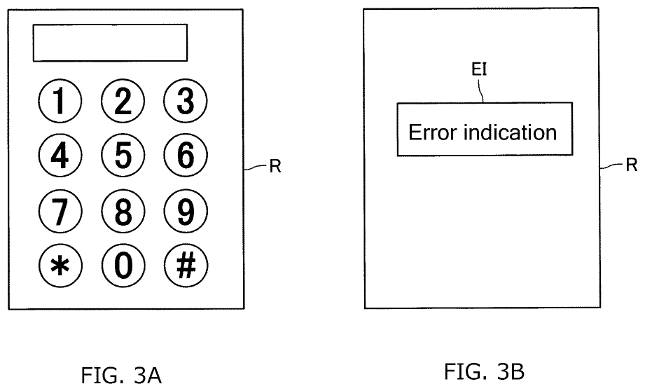

Configuration of Contactless Information Processing Device FIGS. 1A and 1B are schematic diagrams for explaining a configuration of a non-contact-type information processing device 1 according to an embodiment of the present invention. FIG. 2 is a schematic diagram for explaining a configuration of an aerial-image display device 3 used in the non-contact-type information processing device 1 shown in FIG. 1. FIGS. 3A and 3B are diagrams illustrating an example of an aerial image displayed in the aerial-image display region R shown in FIGS. 1A and 1B.

The non-contact-type information processing device 1 (hereinafter referred to as an “information processing device 1”) in this embodiment is a device for contactless and manual communication of information with a contactless IC card 2 (hereinafter, referred to as a “card 2”), which is a communication target and is used in ATMs, authentication devices for credit card payments and the like, automatic ticketing machines, vending machines, or access control devices, for example. An annularly formed antenna for communication is incorporated in the card 2. The information processing device 1 of this embodiment is also an input device for inputting information using a user's fingertips, and in the information processing device 1, a PIN is input, for example. Information other than the PIN may be input in the information processing device 1. For example, the user's signature (signature) may be input in the information processing device 1.

The information processing device 1 has an aerial-image display device 3 that displays an aerial image in a three-dimensional space, a detection mechanism 4 for detecting a position of the user's fingertip in an aerial-image display region R in which the aerial image is displayed, an enclosure 5 that accommodates the aerial-image display device 3 and the detection mechanism 4, an annularly formed antenna 6 for communication, and an annular substrate 7 on which the antenna 6 is mounted. The information processing device 1 also includes a control portion 8 for controlling the information processing device 1. In FIG. 1B, the detection mechanism 4, the antenna 6, the substrate 7 and the like are not shown.

The aerial-image display device 3 has a display mechanism 11 having a display surface 11a for displaying images, and an aerial-image forming mechanism 12 that projects the image displayed on the display surface 11a into a space to form an image as an aerial image. The display mechanism 11 and the aerial-image forming mechanism 12 are accommodated in the enclosure 5. The aerial-image forming mechanism 12 has a beam splitter 13 and a retroreflective material 14. In the following explanation, a Y-direction in FIG. 2, which is orthogonal to an up-down direction (vertical direction), is referred to as a left-right direction, and a direction orthogonal to the up-down direction and the left-right direction is referred to as a front-back direction. An X1-direction side in FIG. 2, which is one side in the front-back direction, is assumed to be a “front” side, and an X2-direction side in FIG. 2, which is a side opposite to that, is assumed to be a “back” side. In this embodiment, a user standing on a front side of the information processing device 1 performs a predetermined operation on a front surface side of the information processing device 1.

The display mechanism 11 is, for example, a liquid crystal display or an organic EL display, and the display surface 11a is a display screen. The display surface 11a faces diagonally forward and downward. The beam splitter 13 is formed as a flat plate. The beam splitter 13 is disposed on the front side of the display mechanism 11. The beam splitter 13 reflects a part of light emitted from the display surface 11a. That is, a surface on one side of the beam splitter 13 is a reflective surface 13a that reflects a part of the light emitted from the display surface 11a. The reflective surface 13a faces diagonally rearward and downward.

A retroreflective material 14 is formed as a flat plate. The retroreflective material 14 is disposed on a lower side of the display mechanism 11 and is disposed on a rear side of the beam splitter 13. To the retroreflective material 14, the light reflected by the beam splitter 13 is incident. The retroreflective material 14 reflects the incident light in the same direction as the incident direction toward the beam splitter 13. In other words, the surface on the one side of the retroreflective material 14 is a retroreflective surface 14a, to which the light reflected by the beam splitter 13 is incident, and also reflects the incident light in the same direction as the incident direction toward the beam splitter 13. A quarter-wavelength plate is attached to the retroreflective surface 14a. The retroreflective surface 14a faces diagonally forward and upward.

A part of the light emitted from the display surface 11a of the display mechanism 11 is reflected by the reflective surface 13a of the beam splitter 13 and enters the retroreflective surface 14a of the retroreflective material 14. The light reflected by the reflective surface 13a is directed diagonally rearward and downward. The light incident to the retroreflective surface 14a is reflected in the same direction as the incident direction of the light to the retroreflective surface 14a. The light reflected by the retroreflective surface 14a goes diagonally forward and upward and passes through the beam splitter 13. In this embodiment, an optical axis L1 of the light emitted from the display surface 11a and an optical axis L2 of the light reflected by the beam splitter 13 are orthogonal. The optical axis of the light reflected by the retroreflective material 14 matches the optical axis L2.

The light transmitted through the beam splitter 13 forms an aerial image in the aerial-image display region R. The aerial-image display region R is disposed diagonally forward and upward of the beam splitter 13. The aerial image formed in the aerial-image display region R is recognized by a user standing in front of the information processing device 1 as an image inclined downward as it moves toward the front side.

The enclosure 5 is formed, for example, having a shape of a cuboid. The enclosure 5 is formed of a resin. The enclosure 5 includes a frame body 17 that surrounds the aerial-image display region R. The frame body 17 is formed having a rectangular or regular-square frame shape and is formed having a flat plate shape. The frame body 17 constitutes a front upper surface of the enclosure 5. The frame body 17, which is formed having a flat plate shape, is inclined downward as it goes toward the front side. An inner peripheral side of the frame body 17 is an opening portion 17a that leads to an inside of the enclosure 5. The opening portion 17a is formed having a rectangular or regular-square shape. The aerial-image display region R is formed in the opening portion 17a. The aerial-image display region R serves as an input portion 18 for the user to input information using the fingertips.

The detection mechanism 4 is accommodated in the enclosure 5. The detection mechanism 4 detects a position of the user's fingertip in the aerial-image display region R as described above. In other words, the input portion 18 is included in a detection range of the detection mechanism 4. The detection mechanism 4 is an optical sensor. Specifically, the detection mechanism 4 is an infrared sensor. In addition, the detection mechanism 4 is a line sensor. The detection mechanism 4 includes a light emitting portion which emits infrared light and a light receiving portion to which the infrared light emitted from the light emitting portion and reflected by the user's fingertip is incident. The detection mechanism 4 is disposed on the side of the opening portion 17a. The detection mechanism 4 detects the position of the user's fingertip in a plane containing the aerial-image display region R (that is, in the plane containing the input portion 18).

The substrate 7 is, for example, a flexible printed circuit board. The substrate 7 is formed having a rectangular or regular-square frame shape. An inner peripheral side of the substrate 7 is a rectangular or regular-square shaped through hole 7a. The antenna 6 is an antenna coil (loop antenna) formed by a coil wound in an annular state. The antenna 6 is formed having a rectangular or regular-square annular shape and is mounted on the substrate 7 so as to surround the through hole 7a. On the substrate 7, an antenna circuit to which the antenna 6 is connected or the like is mounted.

The substrate 7 is fixed to the frame body 17. Specifically, the substrate 7 is fixed to a surface on the rear lower side of the frame body 17. A part of the substrate 7 overlaps the detection mechanism 4. The through hole 7a is larger than the opening portion 17a, and the substrate 7 is disposed on the outer peripheral side of the opening portion 17a. The aerial-image display region R is formed in the through hole 7a. In other words, the aerial-image display region R is formed on the inner peripheral side of the substrate 7. Moreover, the antenna 6, which is mounted on the substrate 7 so as to surround the through hole 7a, is disposed on the outer peripheral side of the aerial-image display region R so as to surround the aerial-image display region R.

The information processing device 1 can conduct contactless communication of information between the information processing device 1 and the card 2 when the user holds the card 2 over the information processing device 1. Moreover, in the information processing device 1, the user can input information such as a PIN using a fingertip in the input portion 18.

In a standby mode in which a user operation is not being performed in the information processing device 1, the display mechanism 11 displays on the display surface 11a an image (image for mode selection) for selecting either one of a communication mode for communicating between the information processing device 1 and the card 2 and an input mode for inputting information in the input portion 18, and the aerial-image forming mechanism 12 displays the image for mode selection displayed on the display surface 11a as an aerial image in the aerial-image display region R, for example. The user selects the mode using a fingertip in the image for mode selection displayed in the aerial-image display region R. The selected mode is recognized by the control portion 8 on the basis of the detection result of the detection mechanism 4 (that is, the detection result of a position (movement) of the user's fingertip).

When the communication mode is selected in the image for mode selection, the display mechanism 11 displays a predetermined mark M for indicating a center position of the antenna 6 on the display surface 11a, and the aerial-image forming mechanism 12 displays the mark M displayed on the display surface 11a in the aerial-image display region R as an aerial image (see FIG. 1A). The mark M is, for example, a logo mark (ripple mark) specified in EMV, which is the international standard. The user holds the card 2 using the mark M displayed in the aerial-image display region R as a landmark.

In this embodiment, when the communication mode is selected, the control portion 8 determines whether normal communication between the card 2 and the information processing device 1 has been completed or not on the basis of a reception result of the antenna 6, and when a communication error that does not complete normal communication between the card 2 and the information processing device 1 occurs, the control portion 8 executes error notification control to notify the user that a communication error has occurred. In the error notification control, the display mechanism 11 displays a predetermined error indication EI on the display surface 11a to notify the communication error, and the aerial-image forming mechanism 12 displays the error indication EI displayed on the display surface 11a in the aerial-image display region R as an aerial image (see FIG. 3B).

The error indication EI displayed in the aerial-image display region R is, for example, a predetermined error message. In addition, the error indication EI may also include an indicator or the like to indicate a reception level of radio waves by the antenna 6. Moreover, the error indication EI may also include an arrow or the like to guide the card 2 to an appropriate position with respect to the antenna 6.

On the other hand, when the input mode is selected in the image for mode selection, the display mechanism 11 displays a keypad for inputting a PIN or the like in the display surface 11a, for example, and the aerial-image forming mechanism 12 displays the keypad displayed on the display surface 11a in the aerial-image display region R as an aerial image (see FIG. 3A). The user inputs the PIN or the like by using the keypad displayed in the aerial-image display region R. Specifically, the user inputs the PIN or the like by sequentially moving the fingertip to the position of a predetermined key (number) in the keypad displayed in the aerial-image display region R. In other words, the user sequentially moves his/her fingertip in the input portion 18 and inputs the PIN and the like. The PIN and the like input in the input portion 18 is recognized by the control portion 8 on the basis of the detection result of the detection mechanism 4.

### Main Effect of this Embodiment

As explained above, in this embodiment, the antenna 6 is disposed on the outer peripheral side of the aerial-image display region R so as to surround the aerial-image display region R. In addition, in this embodiment, when the communication mode is selected, the mark M indicating the center position of the antenna 6 is displayed in the aerial-image display region R. Thus, in this embodiment, the disposed position of the antenna 6 can be easily notified to the user by using the mark M displayed in the aerial-image display region R. Moreover, in this embodiment, since the antenna 6 is disposed on the outer peripheral side of the aerial-image display region R, the antenna 6 can be disposed at a position away from the conductor. Therefore, in this embodiment, the antenna 6 can be disposed at a position where the communication characteristics of the antenna 6 can be easily secured.

In this embodiment, in the error notification control for notifying the user that a communication error has occurred, the display mechanism 11 displays the error indication EI on the display surface 11a to notify the user of the communication error, and the aerial-image forming mechanism 12 displays the error indication EI displayed on the display surface 11a as an aerial image in the aerial-image display region R. Therefore, in this embodiment, occurrence of a communication error can be easily notified to the user.

### Other Embodiments

The embodiment described above is an example of a preferred embodiment of the present invention but it is not limiting, and various modifications can be made within a range not changing the gist of the present invention.

In the embodiment described above, indication other than the mark M may be displayed in the aerial-image display region R when the communication mode is selected. Even in this case, the disposed position of the antenna 6 can be easily notified to the user by using the indication displayed in the aerial-image display region R. In addition, in the embodiment described above, the error indication EI is displayed in the aerial-image display region R in the error notification control, but in addition to or instead of displaying of the error indication EI in the aerial-image display region R in the error notification control, an error sound may be generated. In this case, the information processing device 1 includes an error-sound generating mechanism that generates an error sound.

In the embodiment described above, the detection mechanism 4 may be a capacitance sensor or a motion sensor. In addition, the detection mechanism 4 may be constituted by two cameras. Moreover, in the embodiment described above, the through hole 7a in the substrate 7 may be smaller than the opening portion 17a. In this case, an inner peripheral end of the substrate 7 is disposed on the inner peripheral side of the opening portion 17a. Furthermore, in the embodiment described above, the substrate 7 may be a rigid substrate such as a glass epoxy substrate or the like.

In the embodiment described above, the optical axis L1 of the light emitted from the display surface 11a and the optical axis L2 of the light reflected by the beam splitter 13 does not need to be orthogonal. In addition, in the embodiment described above, the display surface 11a may face diagonally upward, or it may face forward or backward. Moreover, in the embodiment described above, the communication target with which the information processing device 1 communicates information may be an information recording medium other than the card 2 or an electronic device such as a smartphone or the like. Moreover, in the embodiment described above, the information processing device 1 does not have to include a function as an input device. In this case, the information processing device 1 does not need to include the detection mechanism 4. The above description relates to specific examples according to the present invention, and various modifications are possible without departing from the spirit of the present invention. The appended claims are intended to cover such applications within the true scope and spirit of the invention.

### DESCRIPTION OF REFERENCE NUMERALS

1 Information processing device (non-contact-type information processing device)
2 Card (IC card, communication target)
5 Enclosure
6 Antenna
7 Substrate
8 Control portion
11 Display mechanism
11a Display surface
12 Aerial-image forming mechanism
17 Frame body
EI Error indication
M Mark
R Aerial-image display region

1. A non-contact-type information processing device for contactless and manual communication of information with a communication target, comprising:
a display mechanism having a display surface which displays an image;
an aerial-image forming mechanism which forms an image as an aerial image by projecting the image displayed on the display surface to a space; and
an annularly formed antenna for communication, wherein
the antenna is disposed on an outer peripheral side of an aerial-image display region so as to surround the aerial-image display region in which the aerial image is displayed.

2. The non-contact-type information processing device according to claim 1, further comprising:
an annular substrate on which the antenna is mounted, wherein
the aerial-image display region is formed on an inner peripheral side of the substrate.

3. The non-contact-type information processing device according to claim 2, further comprising:
an enclosure in which the display mechanism and the aerial-image forming mechanism are accommodated, wherein
the enclosure includes a frame body which surrounds the aerial-image display region; and
the substrate is fixed to the frame body.

4. The non-contact-type information processing device according to claim 1, wherein
the display mechanism displays a predetermined mark on the display surface to indicate a center position of the antenna; and
the aerial-image forming mechanism displays the mark displayed on the display surface, as the aerial image in the aerial-image display region.

5. The non-contact-type information processing device according to claim 1, further comprising:
a control portion controlling the non-contact-type information processing device, wherein
the control portion determines, based on a reception result of the antenna, whether normal communication has been completed between the communication target and the non-contact-type information processing device or not and, if a communication error that normal communication has not been completed between the communication target and the non-contact-type information processing device occurs, executes error notification control for notifying the occurrence of the communication error to a user; and
in the error notification control, the display mechanism displays predetermined error indication on the display surface to notify the user of the communication error, and the aerial-image forming mechanism displays the error indication displayed on the display surface, as the aerial image in the aerial-image display region.

6. The non-contact-type information processing device according to claim 2, wherein
the display mechanism displays a predetermined mark on the display surface to indicate a center position of the antenna; and
the aerial-image forming mechanism displays the mark displayed on the display surface, as the aerial image in the aerial-image display region.

7. The non-contact-type information processing device according to claim 3, wherein
the display mechanism displays a predetermined mark on the display surface to indicate a center position of the antenna; and
the aerial-image forming mechanism displays the mark displayed on the display surface, as the aerial image in the aerial-image display region.

8. The non-contact-type information processing device according to claim 2, further comprising:
a control portion controlling the non-contact-type information processing device, wherein
the control portion determines, based on a reception result of the antenna, whether normal communication has been completed between the communication target and the non-contact-type information processing device or not and, if a communication error that normal communication has not been completed between the communication target and the non-contact-type information processing device occurs, executes error notification control for notifying the occurrence of the communication error to a user; and
in the error notification control, the display mechanism displays predetermined error indication on the display surface to notify the user of the communication error, and the aerial-image forming mechanism displays the error indication displayed on the display surface, as the aerial image in the aerial-image display region.

9. The non-contact-type information processing device according to claim 3, further comprising:
a control portion controlling the non-contact-type information processing device, wherein
the control portion determines, based on a reception result of the antenna, whether normal communication has been completed between the communication target and the non-contact-type information processing device or not and, if a communication error that normal communication has not been completed between the communication target and the non-contact-type information processing device occurs, executes error notification control for notifying the occurrence of the communication error to a user; and
in the error notification control, the display mechanism displays predetermined error indication on the display surface to notify the user of the communication error, and the aerial-image forming mechanism displays the error indication displayed on the display surface, as the aerial image in the aerial-image display region.
